(19) United States
(12) Patent Application Publication
(10) Pub. No.: US 2020/0121145 A1
(43) Pub. Date: Apr. 23, 2020

(54) CYCLONIC SEPARATOR DEVICE

(71) Applicant: TTI (MACAO COMMERCIAL OFFSHORE) LIMITED, Macau (CN)

(72) Inventor: Simon Matthew Pougher, Chester Cheshire (GB)

(21) Appl. No.: 16/624,688

(22) PCT Filed: Jun. 15, 2018
(86) PCT No.: PCT/GB2018/051656

§ 371 Date: Dec. 19, 2019

(30) Foreign Application Priority Data
Jun. 19, 2017 (GB) PCT/GB2017/051786
Jun. 19, 2017 (GB) PCT/GB2017/051788

(51) Int. Cl. A47L 9/16; A47L 9/32; B04C 5/26; A47L 5/24; A47L 5/36; A47L 9/14; A47L 9/10; B04C 5/187; A47L 9/24

(52) U.S. Cl. CPC A47L 9/1633; A47L 9/327; B04C 5/26; A47L 5/24; A47L 9/1683; A47L 9/1658; A47L 9/165; A47L 5/36; A47L 9/1409; A47L 9/102; B04C 5/187; A47L 9/242; A47L 9/322

(57) ABSTRACT

A cyclonic separator device for removing dust or debris from dirt-laden air, the device including: a first separating chamber for separating relatively coarse dust or debris from the dirt-laden air; an inlet through which dirt-laden air is drawn into the first separating chamber; a first dirt collection chamber in communication with the first separating chamber; a shroud; a second separating chamber positioned generally within the shroud for separating relatively fine dust or debris from the dirt-laden air cleaned by the first separating chamber, a second dirt collection chamber in communication with the second separating chamber; an outlet through which cleaner air exits the second separating chamber; wherein the first separating chamber includes a generally cylindrical portion with a central axis and wherein the inlet is configured to direct the incoming dirt-laden air into said generally cylindrical portion such that it travels circumferentially around an inner surface of the first separating chamber, wherein the shroud is positioned generally centrally of the generally cylindrical portion of the first separating chamber and the shroud has a generally cylindrical portion with openings therein for the passage of air therethrough towards the second separating chamber, wherein the second dirt separating chamber includes: an inlet through which cleaned dirt-laden air exiting the first separating chamber is drawn into the second separating chamber; a generally frusto-conical portion with a central axis and the frusto-conical portion has an end-part in communication with the second dirt collection chamber through which fine dust or debris exits therethrough into the second dirt collection chamber, and wherein the inlet of the second separating chamber is configured to direct the incoming said cleaned dirt-laden air such that it travels circumferentially around an inner surface of the generally frusto-conical portion, and wherein the second dirt collection chamber includes: a first portion which surrounds an outer surface of the end part of the frusto-conical portion to define a space S1 therebetween; and a second portion connected to the first portion, wherein the first portion has a greater cross-sectional area than the second portion.

### DESCRIPTION OF INVENTION

This invention relates to a cyclonic separation device and particularly, but not exclusively, to a surface cleaning apparatus including such a device.

In more detail, the invention relates to improving the performance of a cyclonic separating device by optimising certain characteristics and dimensions of the various component parts of the device, for example, in relation to optimising the performance of a cyclonic separating device which is horizontal or otherwise inclined in normal use.

According to an aspect of the present invention we provide a cyclonic separator device for removing dust or debris from dirt-laden air, the device including:
a first separating chamber for separating relatively coarse dust or debris from the dirt-laden air;
an inlet through which dirt-laden air is drawn into the first separating chamber;
a first dirt collection chamber in communication with the first separating chamber;
a shroud;
a second separating chamber positioned generally within the shroud for separating relatively fine dust or debris from the dirt-laden air cleaned by the first separating chamber,
a second dirt collection chamber in communication with the second separating chamber;
an outlet through which cleaner air exits the second separating chamber;
wherein the first separating chamber includes a generally cylindrical portion with a central axis and wherein the inlet is configured to direct the incoming dirt-laden air into said generally cylindrical portion such that it travels circumferentially around an inner surface of the first separating chamber,
wherein the shroud is positioned generally centrally of the generally cylindrical portion of the first separating chamber and the shroud has a generally cylindrical portion with openings therein for the passage of air therethrough towards the second separating chamber,
wherein the second dirt separating chamber includes:
   an inlet through which cleaned dirt-laden air exiting the first separating chamber is drawn into the second separating chamber;
   a generally frusto-conical portion with a central axis and the frusto-conical portion has an end-part in communication with the second dirt collection chamber through which fine dust or debris exits therethrough into the second dirt collection chamber, and wherein the inlet of the second separating chamber is configured to direct the incoming said cleaned dirt-laden air such that it travels circumferentially around an inner surface of the generally frusto-conical portion, and
wherein the second dirt collection chamber includes:
   a first portion which surrounds an outer surface of the end part of the frusto-conical portion to define a space S1 therebetween; and
   a second portion connected to the first portion,
wherein the first portion has a greater cross-sectional area than the second portion.

According to an aspect of the invention we provide a cyclonic separator device for removing dust or debris from dirt-laden air, the device including:
a first separating chamber for separating relatively coarse dust or debris from the dirt-laden air;
an inlet through which dirt-laden air is drawn into the first separating chamber;
a first dirt collection chamber in communication with the first separating chamber;
a shroud;
a second separating chamber positioned generally within the shroud for separating relatively fine dust or debris from the dirt-laden air cleaned by the first separating chamber,
an inlet through which cleaned dirt-laden air exiting the first separating chamber is drawn into the second separating chamber;
a second dirt collection chamber in communication with the second separating chamber;
an outlet through which cleaner air exits the second separating chamber;
wherein the first separating chamber includes a generally cylindrical portion with a central axis and wherein the inlet is configured to direct the incoming dirt-laden air into said generally cylindrical portion such that it travels circumferentially around an inner surface of the first separating chamber,
wherein the shroud is positioned generally centrally of the generally cylindrical portion of the first separating chamber and the shroud has a generally cylindrical portion having a height D with openings therein for the passage of air therethrough towards the second separating chamber,
wherein the second separating chamber optionally or preferably includes:
   a generally frusto-conical portion with a central axis and the generally frusto-conical portion has an end part in communication with the second dirt collection chamber through which fine dust or debris exits therethrough into the second dirt collection chamber, and wherein the inlet of the second separating chamber is configured to direct the incoming said cleaned dirt-laden air such that it travels circumferentially around an inner surface of the generally frusto-conical portion, and
   wherein a first portion of the second dirt collection chamber surrounds an outer surface of the end part of the generally frusto-conical portion to define a space S1 therebetween and said first portion of the second dirt collection chamber extends into a space S2 defined by the inner surface of the generally cylindrical portion of the shroud having said openings therein.

The first portion of the second dirt collection chamber may extend a height H into said space S2, and wherein the ratio (H:D) between height H and the height D of the generally cylindrical portion of the shroud is defined by the range:
1:1.2≤H:D≤1:4.5.

The ratio (H:D) may be defined by the range:
1:1.6≤H:D≤1:2.0

The ratio (H:D) may be defined by the range:
1:1.6≤H:D≤1:1.8.

The ratio (H:D) may be or be about 1:1.7.

The second dirt collection chamber may include a second portion connected to the first portion, wherein the first portion has a greater cross-sectional area than the second portion.

Said first portion of the second dirt collection chamber may extend into a space S2 defined by the inner surface of the generally cylindrical portion of the shroud having said openings defined therein.

The first portion of the second dirt collection chamber may have an end which is in sealed engagement or substantially sealed engagement with the end part of the frusto-conical portion.

Optionally the first portion of the second dirt collection chamber has a height H about its central axis, and the generally frusto-conical portion of the second separating chamber has a height H2 along its central axis, and wherein the ratio (H:H2) between them is defined by the range:
1:1.2≤H:H2≤1:7.

Optionally the ratio (H:H2) is defined by the range:
1:1.3≤H:H2≤1:5.

Optionally the ratio (H:H2) is defined by the range
1:1.4≤H:H2≤1:4.5.

Optionally the ratio (H:H2) is or is about 1:4.3.

Optionally:
the first portion of the second dirt collecting chamber is generally cylindrical and has a diameter D1 across its inner surface; and
the second portion of the second dirt collecting chamber is generally cylindrical and has a diameter D2 across its inner surface,
wherein the ratio (D1:D2) is defined by the range:
1.05:1≤D1:D2≤1.60:1.

Optionally the ratio (D1:D2) is defined by the range:
1.07:1≤D1:D2≤1.20:1.

Optionally the ratio (D1:D2) is defined by the range:
1.07:1≤D1:D2≤1.15:1.

Optionally the ratio (D1:D2) is defined by the range:
1.07:1≤D1:D2≤1.13:1.

Optionally the ratio (D1:D2) is defined by the range:
1.07:1≤D1:D2≤1.1:1.

Optionally the ratio (D1:D2) is 1:09:1.

Optionally a third portion which is frusto-conical connects the first portion to the second portion.

Optionally the second dirt collection chamber includes a baffle positioned generally centrally thereof and which extends from a lower end of the second portion of the second dirt collection chamber upwardly towards the first portion of the second dirt collection chamber.

Optionally the baffle terminates in a conical portion.

Optionally the conical portion extends into the end part of the frusto-conical portion of the second separating chamber.

Optionally an outer diameter U of the first portion of the second dirt collection chamber and an inner diameter V of the cylindrical portion of the shroud satisfy a ratio (U:V) defined by the range:
1:1.1≤U:V≤1:1.5.

Optionally the ratio (U:V) defined by the range:
1:1.2≤U:V≤1:1.4.

Optionally the ratio (U:V) is or is about 1:1.3.

According to an aspect of the present invention we provide a cyclonic separator for removing dust or debris from dirt-laden air, the device including:
a first separating chamber for separating relatively coarse dust or debris from the dirt-laden air;
an inlet through which dirt-laden air is drawn into the first separating chamber;
a first dirt collection chamber in communication with the first separating chamber;
a shroud;
an outlet through which cleaner air exits the first separating chamber;
wherein the first separating chamber includes a generally cylindrical portion with a central axis and wherein the inlet is configured to direct the incoming dirt-laden air into said generally cylindrical portion such that it travels circumferentially around an inner surface of the first separating chamber,
wherein the shroud is positioned generally centrally of the generally cylindrical portion of the first separating chamber and the shroud has a generally cylindrical portion having a height D with openings therein for the passage of air,
wherein the generally cylindrical portion of the shroud has an outer diameter K and the first separating chamber has an inner diameter P and wherein the ratio (K:P) lies in the range:
1:1.2≤K:P≤1:1.5.

Optionally the ratio (K:P) lies in the range:
1:1.3≤K:P≤1:1.5.

Optionally the ratio (K:P) lies in the range:
1:1.35≤K:P≤1:1.45.

Optionally the ratio (K:P) is or is about 1:1.39.

Optionally the generally cylindrical portion of the shroud has an outer diameter K in the range of 86-90 mm, optionally or preferably in the range of 87-89 mm, optionally or preferably K is or is about 87.7 mm.

Optionally the generally cylindrical portion of the shroud has an outer surface which is spaced a distance J from an inner surface of the generally cylindrical portion of the first separating chamber in the range of 15-18 mm, preferably in the range of 16-18 mm, optionally or preferably in the range of 16.5-17.5 mm, optionally or preferably in the range of 16.7-17.1 mm, optionally or preferably J is or is about 16.9 mm.

Optionally the shroud includes a peripheral skirt wherein the skirt has an outer diameter which is equal to an outer diameter of the generally cylindrical portion of the shroud.

Optionally an inner diameter P of the generally cylindrical portion of the first separating chamber is in the range of 120-125 mm, optionally or preferably in the range of 120-124 mm, optionally or preferably in the range of 121.5-123.5 mm, optionally or preferably P is or is about 122.4 mm.

Optionally the shroud includes a peripheral skirt which extends towards an end of the first dirt collection chamber, wherein a free peripheral edge of the skirt is spaced a distance M from an inner surface of the end of the first dirt collection chamber at a distance in the range of 35-45 mm, optionally or preferably in the range of 36-44 mm, optionally or preferably in the range of 36-39 mm, optionally or preferably in the range of 36-38 mm, optionally or preferably in the range of 36.5-37.5 mm, and optionally or preferably the distance M is or is about 37.2 mm.

Optionally an end of the generally cylindrical portion of the shroud faces an inner surface of an end of the first dirt collection chamber, wherein said end of the generally cylindrical portion of the shroud is spaced from the inner surface of an end of the first dirt collection chamber a distance N in the range of 60-70 mm, optionally or preferably in the range of 61-69 mm, optionally or preferably in the range of 62-67 mm, optionally or preferably in the range of 63-67 mm, optionally or preferably in the range of 64-66 mm, and optionally or preferably the distance N is or is about 65 mm.

Optionally the shroud has a central axis which is substantially coaxial or coaxial with the central axis of the generally cylindrical portion of the first separating chamber.

Optionally the shroud is connected to one end of the first separating chamber and is free at an opposite end.

According to an aspect of the present invention we provide a surface cleaning apparatus including a separator device according to any one of the above recited aspects.

Optionally the apparatus include:
a surface cleaning tool;
a housing supporting a suction source; and
an elongate member connecting the surface cleaning tool to the housing, said elongate member including a passage for carrying dirt-laden air from the floor head to the dirt collection chamber.

Optionally the elongate member is disconnectable from the surface cleaning tool.

Optionally the elongate member is disconnectable from the housing.

Optionally the apparatus are handheld surface cleaning apparatus.

Optionally an axis of the cyclonic separation device extends transverse to an elongate axis of the elongate member.

Optionally an axis of the cyclonic separation device extends perpendicular to an elongate axis of the elongate member.

Optionally the source of suction is a fan rotatable by a motor.

Optionally, in normal use, the first and second cyclonic separating chambers are generally horizontal or the elongate axes thereof are generally horizontal.

Embodiments of the invention will be set out below by way of example only with reference to the accompanying figures, of which:

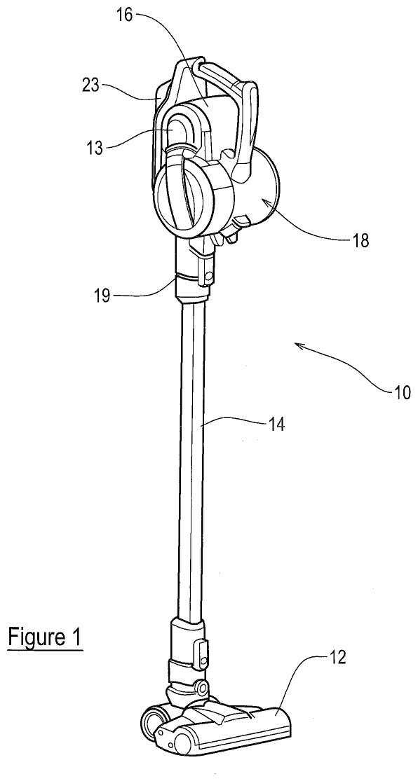

FIG. 1 is a perspective view of a surface cleaning apparatus;

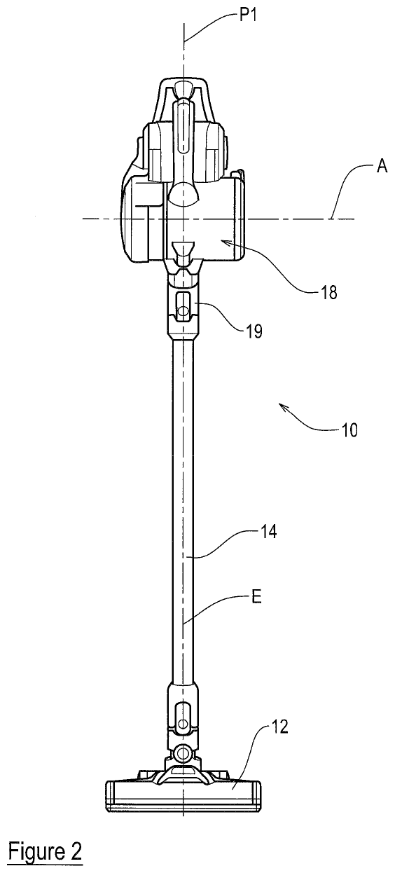

FIG. 2 is a front view of the apparatus of FIG. 1;

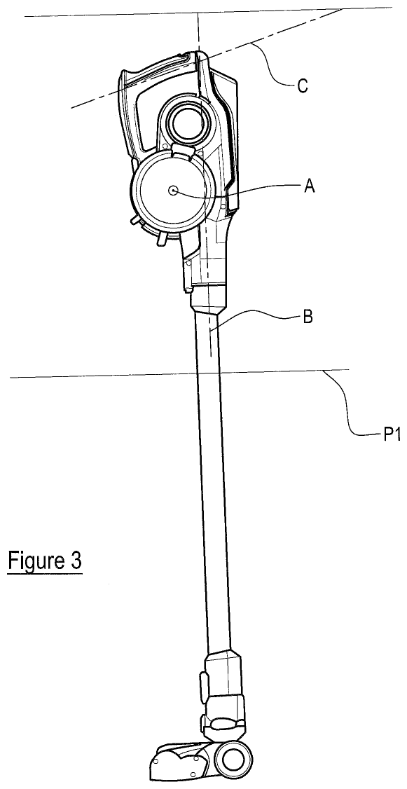

FIG. 3 is a side view of the apparatus FIG. 1;

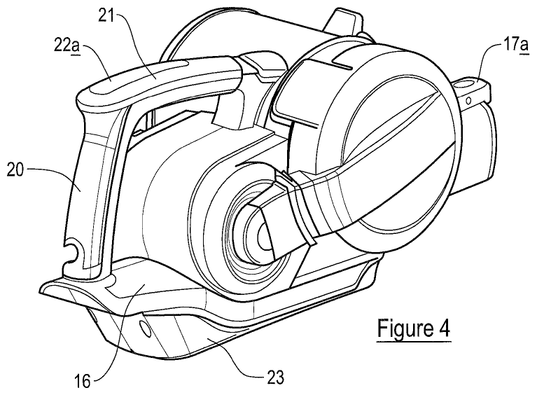

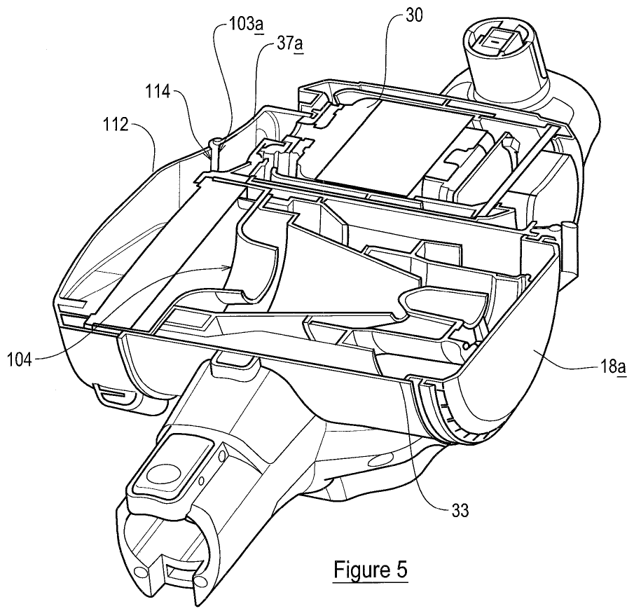

FIG. 4 is a perspective view of a housing of the apparatus of FIG. 1, which housing is operable as a handheld surface cleaning apparatus;

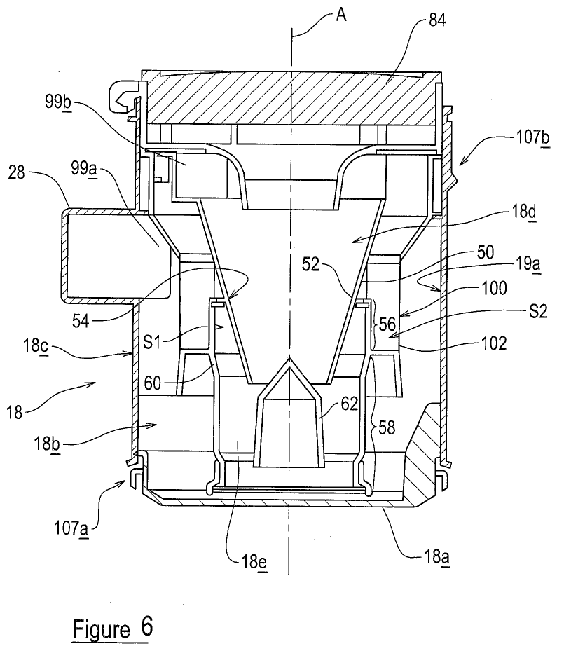

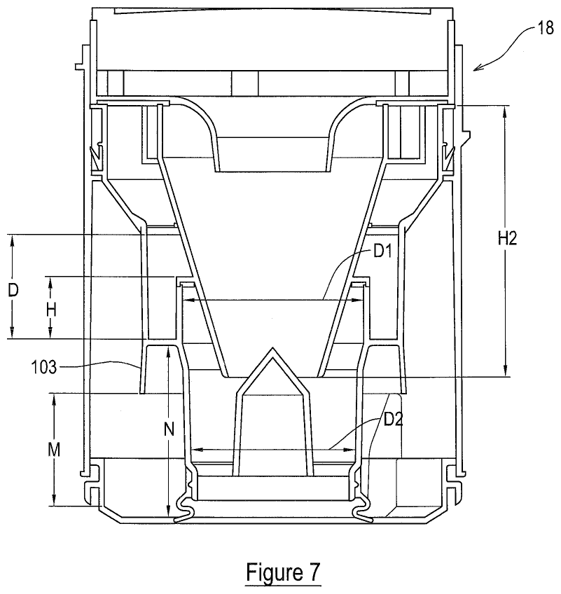

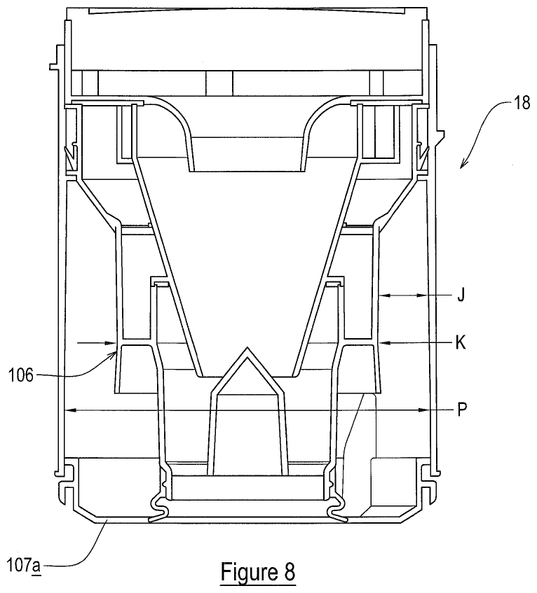

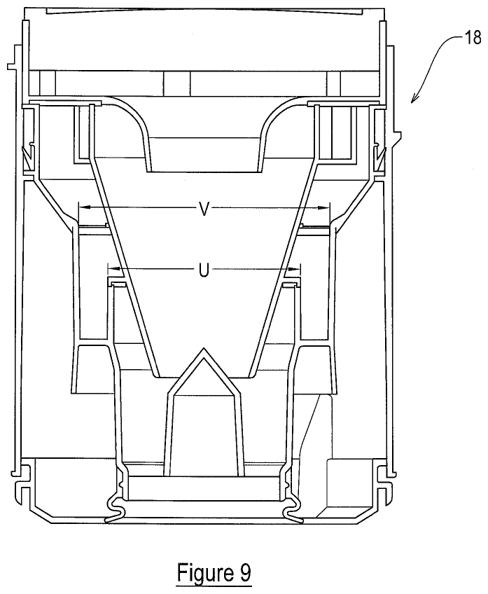

FIGS. 6 to 9 are cross-sectional views of a cyclonic separator device of the apparatus of FIG. 1.

Referring to the figures, these show a surface cleaning apparatus 10 in accordance with the present invention. The apparatus 10 includes a surface cleaning tool 12 (a floor head in this example), a housing 16 having an elongate axis H and an elongate member 14, having an elongate axis E, connecting the surface cleaning tool 12 to the housing 16. The elongate member 14 is relatively rigid. The housing 16, in this example, is operable as a handheld surface cleaning apparatus, commonly known as a hand vac, when the elongate member 14 is not connected thereto, and in this state the housing 16 can be used with or without the surface cleaning tool 12 connected thereto. The housing 16 supports a suction source 13, a dirt separation device 15 including a cyclonic separator device 18. The cyclonic separator device 18 is generally cylindrical and has an elongate axis A. The axis A is the axis about which dirt-laden air is caused to rotate by the cyclonic separator as it passes through the apparatus 10. The cyclonic separator device 18 also includes a filter 84 for cleaning the relatively clean air outputted by the cyclonic separator device 18. In embodiments, the suction source 13 is an electric motor driving a rotatable fan, but any appropriate suction source may be used. All that is necessary is for the suction source to be able to draw air through the surface cleaning tool 12 and elongate member 14 towards the cyclonic separator device 18.

In embodiments, the housing 16 supports or contains a battery 23 to provide electrical power to the suction motor and other components of the apparatus 10. Battery 23 is of a generally elongate shape but may be of a different shape in other embodiments.

In embodiments, the housing 16 includes a passage member 19 in fluid communication with the cyclonic separator device 18. The passage member 19 is generally elongate. Passage member 19 has an elongate axis B. A first end of the passage member 19 defines an inlet 17 for receiving dirt-laden air. The first end is connectable to the elongate member 14 or surface cleaning tool 12. When connected, axis B is parallel to the elongate axis E of the elongate member 14. In embodiments, axis B may be co-axial or offset from the elongate axis E.

In embodiments, the cyclonic separator device 18 includes an inlet passage member 28 for fluidly connecting the passage member 19 to the cyclonic separation device 18. In embodiments, there may be no inlet passage member 28 and instead the passage member 19 communicates with an inlet of the cyclonic separator device directly. In other embodiments, the housing 16 has no passage member and the inlet passage member 28 is formed as part of the dirt separation device 15 and connects to a tool or elongate member directly.

The elongate member 14 includes a passage for carrying dirt-laden air from the surface cleaning tool 12 to the dirt separation device. In this example the surface cleaning tool 12 includes a motor for driving a rotatable floor agitating member or brush, so the elongate member 14 includes a further passage through which electrical cables may extend to provide an electric connection between the housing 16 and the motor in the surface cleaning tool 12.

The surface cleaning tool 12 is disconnectable from the elongate member 14, so that, for example, another tool can be connected to the free end of the elongate member 14. The elongate member 14 is also disconnectable from the housing 16, by way of a manually operated switch 17a. This enables the housing 16 to be used as handheld surface cleaning apparatus, with the option of being able to connect another tool to the location from where the elongate member 14 is removed.

The housing 16 includes a handle for holding the apparatus 10, said handle including first 20 and second 21 user-graspable portions which are connected to each other substantially at right-angles. The dirt separation device 15 is positioned forwardly of the handle. A first end of the first user-graspable portion 20 is connected to the housing 16 and the portion 20 extends generally upwardly and away therefrom. User-graspable portion 20 has an elongate axis C. A first end of the second user-graspable portion 21 is connected to the housing 16 and extends generally rearwardly away therefrom and from the elongate member 14. Respective second ends of the first 20 and second 21 user-graspable portions are connected to each other. Essentially, the first 20 and second 21 user-graspable portions form a handle which is L-shaped and which provides two locations each of which is sized such that it can be grasped fully by a hand of a user. A device 22a, e.g. a switch, for turning the apparatus “on” is positioned at the connection of the second ends of the first 20 and second 21 user-graspable portions to each other.

The suction source 13 is in the form of an electric motor 30 with an axle which is connected at one end to a fan. The motor 30 may be any appropriate motor, e.g. DC, AC, brushless.

An upstream wall 112 of the housing 16 extends along the elongate axis H of the housing 16 and has an inner surface which partially defines an air flow passage from an outlet 104 of the dirt separation device to an inlet 103a of the suction source 13. In more detail, an inlet passage 37a to the suction source 13 defines inlet 103a at an end face thereof and upstream wall 112 defines an outlet 114 at an end face thereof. The end face of passage 37a is provided with a seal which abuts the end face of outlet 114 in a sealing manner when the dirt separation device 15 is attached to the housing 16.

The cyclonic separator device 18 has a first end including the cover 18a and a second end including the upstream wall 112. A cylindrical wall 33 extends between the first and second ends. A portion of the surface of the wall 33 is received by a correspondingly shaped recessed surface of the housing 16.

The cyclonic separator device 18 has first and second dirt collection chambers 18b, 18e provided at one end 107a thereof.

The cyclonic separator device 18 has first and second separating chambers 18c, 18d adjacent the first and second dirt collection chambers 18b, 18e. By referring to chambers 18a, 18d, 18b, 18e, it should be understood that the chambers include walls provided by various components and that those walls define respective one or more surfaces and spaces of the chambers.

The cyclonic separator device 18 includes a shroud 100 which also has an elongate axis coaxial with the axis A, the axis A being that about which dirt-laden air is caused to rotate as it passes through the apparatus 10 and circulates around the shroud 100. Shroud 100 is positioned as part of the cyclonic separator device 18 at an end 107b thereof which is opposite to the end 107a of the cyclonic separator device 18 at which the first and second dirt collection chambers 18b, 18c are provided. The shroud 100 has a free distal end. Shroud 100 has a generally cylindrical portion 102 having openings therein for the passage of air positioned generally centrally of the cyclonic separating device 18. The portion 102 has a height D.

The first separating chamber 18c is for separating relatively coarse dust or debris from the dirt-laden air. The first separating chamber 18c is in communication with the first dirt collection chamber 18b so that separated dust or debris falls into the first dirt collection chamber 18b therefrom.

The second separating chamber 18d is positioned generally within the shroud 100 and is for separating relatively fine dust or debris from the dirt-laden air cleaned by the first separating chamber 18c. The second separating chamber 18d is in communication with the second dirt collection chamber 18e so that separated dust or debris falls into the second dirt collection chamber 18e therefrom.

The cyclonic separator device 18 includes an inlet 99a through which dirt-laden air is drawn into the first separating chamber 18c. The inlet 99a is configured to direct the incoming dirt-laden air into a generally cylindrical portion of the first separating chamber 18c such that it travels circumferentially around an inner surface 19a of the first separating chamber 18c. Whilst in this embodiment the elongate axes of the dirt collection chambers 18c, 18e and the shroud 100 are coaxial or substantially coaxial, they need not be. They could, for example, be parallel and offset from each other or inclined relative to each other. Alternatively, the shroud 100 could be positioned generally centrally of the generally cylindrical portion of one or both of the separating chambers 18c, 18e.

The cyclonic separator device 18 includes an inlet 99b through which cleaned dirt-laden air exiting the first separating chamber 18c is drawn into the second separating chamber 18d. The second separating chamber 18d includes a generally frusto-conical portion 50 with a central axis. The frusto-conical portion 50 has an end part 52 in communication with the second dirt collection chamber 18e through which fine dust or debris exits therethrough into the second dirt collection chamber 18e.

The inlet 99b of the second separating chamber 18e is configured to direct the incoming cleaned dirt-laden air such that it travels circumferentially around an inner surface 54 of the generally frusto-conical portion 50. The use of such a frusto-conical portion 50 may permit the second separating chamber 18d to separate finer dust or debris from the air than that achievable by the first separating chamber 18c.

The second dirt collection chamber 18e includes a first portion 56 positioned near the end part 52 of the generally frusto-conical portion 50 and a second portion 58 connected to the first portion 56 which extends to an end wall of the cyclonic separator device 18 therefrom. The first and second portions 56, 58 are generally cylindrical with the first portion 56 having a greater cross-sectional area than the second portion 58, i.e. as considered without the portion 50 being positioned therein. In other words, the cross-sectional areas referred to are those defined by the respective inner surfaces of the first and second portions 56, 58 as viewed in side cross-section. In embodiments, the respective areas of the cross-sections may be the same or different. A third portion 60 which is frusto-conical connects the second portion 58 to the first portion portion 56.

The suction source 13 is positioned such that its axle extends transversely to the elongate axis H of the housing 16. The axis of the axle and axis A of the cyclonic separator device 18 extend perpendicularly to the elongate axis H of the housing 16. The axes of the axle and dirt collection chamber 18 are also parallel to one another in this embodiment but they may not be in other embodiments. The elongate axis B of the passage member 19 and the elongate axis C of the first user graspable portion 20 of the handle lie in a plane P1, and the elongate axis A of the cyclonic separator device 18 intersects the plane P1 (as shown in FIGS. 2 and 3). The elongate axis A is substantially horizontal in normal use.

Normal use of the surface cleaning apparatus 10 refers to use thereof when the elongate member 14 is inclined at an acute angle with respect to the surface being cleaned. In other embodiments for which the surface cleaning apparatus 10 is a cylinder cleaner, the housing supporting separator device 18 may be generally upright with respect to the floor surface during normal use, and the elongate axis A may be parallel with or inclined with respect to the floor surface. For embodiments where the apparatus 10 is an upright cleaner, the housing may be inclined with respect to the floor surface and the elongate axis A may be parallel or inclined with the floor surface during normal use.

The first portion 56 surrounds the end part 52 of the generally frusto-conical portion 50 to define a space S1 therebetween. The first portion 56 extends upwardly along an elongate axis thereof into a space S2 defined by the inner surface of the generally cylindrical portion 102 of the shroud 100.

The first portion 56 has an end which is in sealed engagement or substantially sealed engagement with the end part 52 of the frusto-conical portion 50.

During use, space S1 may advantageously collect dirt or debris and thus may increase the amount of dirt or debris that may be collected by the second dirt collection chamber 18e. For applications in which axis A of the cyclonic separator device 18 is horizontal (i.e. such as when used in apparatus 10) or inclined during use, the presence of space S1 lessens the likelihood of collected dirt or debris returning into the second separating chamber 18d and thus reducing the cleaning efficiency. An advantage of embodiments of the invention may be that the capacity of the second dirt collection chamber 18e is increased through the provision of the space S1 without having to increase the width of the second portion 58 thereof which would otherwise cause a reduction in the capacity of the first dirt collection chamber 18b and/or interfere with the efficiency of the first separating chamber 18c. It has been realised that it is possible, for embodiments, to utilise part of the space S2 defined by the inner surface of the shroud 10 which defines openings for the passage of air therethrough with satisfactory cleaning efficiency still being achievable.

The second dirt collection chamber 18e includes a baffle 62 positioned generally centrally thereof and which extends upwardly from end 107a of the cyclonic separator device 18. The baffle 62 terminates in a conical portion. The conical portion extends into the end part 52 of the frusto-conical portion 50 of the second separating chamber 18d.

Additionally, advantageously it has been found that performance may be increased for embodiments in which the first portion 50 of the second dirt collection chamber 18e extends a height H into the space S2 which is 10-25 mm, optionally or preferably 15-25 mm, optionally or preferably 19.5-21.5 mm, optionally or preferably the height H is 20 mm. Optionally or preferably H is 20.7 mm. Further improvements are found if the height D of the cylindrical portion 102 of the shroud 100 is 30-45 mm, optionally or preferably 30-40 mm, optionally or preferably 32.5-37.5 mm, or optionally or preferably the height D is 35 mm. Optionally or preferably D is 34.7 mm.

Advantageous synergies have been found between the height H and the height D. For example, in embodiments, improvements are found when the ratio (H:D) lies in the range:
1:1.2≤H:D≤1:4.5

Performance improvements are also found when (H:D) lies in the range:
1:1.5≤H:D≤1:2.7

Performance improvements are also found when (H:D) lies in the range:
1:1.6≤H:D≤1:2.0

Performance improvements are also found if the ratio (H:D) lies in the range:
1:1.6≤H:D≤1:1.8.

Performance improvements are also found when the ratio (H:D) is 1:1.7.

Performance improvements are also found if the ratio (H:D) lies in the range:
1:1.8≤H:D≤1:2.0.

Performance improvements are also found when the ratio (H:D) is 1:1.9.

In embodiments, the generally frusto-conical portion 50 has a height H2 about its central axis which may optionally or preferably be 75-105 mm, optionally or preferably 85-95 mm, optionally or preferably 87.5-92.5 mm, or optionally or preferably H2 may be 90 mm. Optionally or preferably H2 may be 89.5 mm.

Advantageous synergies have been found between the height H and the height H2. For example, in embodiments, improvements are found when the ratio (H:H2) lies in the range:
1:1.2≤H:H2≤1:7.

Performance improvements are also found when (H:H2) lies in the range:
1:1.3≤H:H2≤1:5.3.

Performance improvements are also found if the ratio (H:H2) lies in the range:
1:1.4≤H:H2≤1:4.7

Performance improvements are also found when the ratio (H:H2) is 1:4.5

Performance improvements are also found when (H:H2) lies in the range:
1:3.0≤H:H2≤1:5.0.

Performance improvements are also found if the ratio (H:H2) lies in the range:
1:4.0≤H:H2≤1:4.5

Performance improvements are also found when the ratio (H:H2) is 1:4.3

The first portion 56 has a diameter D1 across its inner surface and the second portion 58 of the second dirt collecting chamber 18e is generally cylindrical and has a diameter D2 across its inner surface.

In embodiments, D1 may optionally or preferably be 50-70 mm, optionally or preferably 55-65 mm, optionally or preferably 57.5-62.5 mm, or optionally or preferably D1 may be 61 mm. Optionally or preferably D1 may be 60.7 mm. In embodiments D2 may optionally or preferably be 45-60 mm, optionally or preferably 50-58 mm, or optionally or preferably 54-58 mm, optionally or preferably 55.5-56.5 mm, optionally or preferably D2 may be 56 mm. Optionally or preferably D2 may be 55.5 mm.

Advantageous synergies have been found between D1 and D2. For example, in embodiments, improvements are found when the ratio (D1:D2) lies in the range:
1.05:1≤D1:D2≤1.60:1.

Performance may also be increased if the ratio (D1:D2) is defined by the range:
1.07:1≤D1:D2≤1.40:1.

Performance may also be increased if the ratio (D1:D2) is defined by the range:
1.07:1≤D1:D2≤1.20:1.

Performance may also be increased if the ratio (D1:D2) is defined by the range:
1.07:1≤D1:D2≤1.15:1.

Performance may also be increased if the ratio (D1:D2) is defined by the range:
1.07:1≤D1:D2≤1.13:1.

Performance may also be increased if the ratio (D1:D2) is 1:09:1.

The first portion 56 of the second dirt collection chamber 18e has an outer diameter U and the cylindrical portion 102 of the shroud 100 has an inner diameter V. Advantageous synergies have been found between U and V. For example, in embodiments, improvements are found when the ratio (U:V) lies in the range:
1:1.1≤U:V≤1:1.5.

Performance is also increased if the ratio (U:V) is defined by the range:
1:1.2≤U:V≤1:1.4.

Performance may also be increased if the ratio (U:V) is or is about 1:1.3.

In embodiments, the outer diameter U of the first portion of the second dirt collection chamber is in the range 62-67 mm, optionally or preferably 63-65 mm, or optionally or preferably 63.5-64.5 mm, optionally or preferably the outer diameter U is 64 mm. Optionally or preferably U is 65.3 mm. In embodiments, the inner diameter V of the cylindrical portion of the shroud is in the range 78-88 mm, optionally or preferably 80-86 mm, optionally or preferably 82.5-83.5 mm, optionally or preferably the inner diameter V is 83.0 mm. Optionally or preferably V is 85 mm.

The cyclonic separator device 18 includes an outlet through which cleaner air exits the second separating chamber 18d.

In more detail, shroud 100 has a generally cylindrical portion 102 having a height D. The generally central portion 102 of the shroud 100 includes a framework to support a mesh or the like (not shown) and has openings therein for the passage of air to the inlet 99b. Other configurations of the portion 102 are envisaged, for example removing the mesh covering and instead making the openings 104 smaller and greater in number.

It has been found that performance is improved for embodiments in which the generally cylindrical portion 102 has an outer diameter K in the range of 87-91 mm, optionally or preferably in the range of 89-91 mm, and optionally or preferably the outer diameter K is or is about 90 mm. Optionally or preferably for embodiments K is in the range of 86-90 mm, optionally or preferably in the range of 87-89 mm Optionally or preferably K is 87.7 mm.

Additionally, it has been found that performance is improved in embodiments for which an outer surface of the portion 102 (or it's covering, if there is one) is spaced at J from the inner surface 18d of the separating chamber 18c in the range of 15-17 mm, preferably in the range of 15-17 mm, optionally or preferably in the range of 15.5-16.5 mm, optionally or preferably in the range of 15.75-16.25 mm, optionally or preferably in the range of 15.9-16.1 mm, and optionally or preferably the distance J is 16 mm or about 16 mm. Optionally or preferably for embodiments, J is in the range of 15-18 mm, preferably in the range of 16-18 mm, optionally or preferably in the range of 16.5-17.5 mm, optionally or preferably in the range of 16.7-17.1 mm. Optionally or preferably J is 16.9 mm.

As regards the dimensions of the first separating chamber 18c, in embodiments, it has been found that performance is improved where an inner diameter P of the generally cylindrical portion of the separating chamber 18c is in the range of 121-127 mm, optionally or preferably in the range of 123-125 mm, optionally or preferably in the range of 123.5-124.5 mm, or optionally or preferably the distance P is 124.0 mm or about 124.0 mm. Optionally or preferably for embodiments P is in the range of 120-125 mm, optionally or preferably in the range of 120-124 mm, optionally or preferably in the range of 121.5-123.5 mm. Optionally or preferably P is 122.4 mm.

Advantageous synergies have been found between the diameter P and the outer diameter K of the generally cylindrical portion 102 of the shroud 100. For example, in embodiments, improvements are found when the ratio (K:P) lies in the range:
1:1.2≤K:P≤1:1.5.

Performance improvements are also found when (K:P) lies in the range:
1:1.3≤K:P≤1:1.5.

Performance improvements are also found if the ratio (K:P) lies in the range:
1:1.35≤K:P≤1:1.45.

Performance improvements are also found when the ratio (K:P) is 1:1.38.

Performance improvements are also found when the ratio (K:P) is 1:1.39.

The generally cylindrical portion 102 of the shroud 100 terminates at an end 106 which faces an inner surface of end 107a of the first dirt collection chamber 18b, e.g. which faces the pivotally moveable door 18a. It has been found that performance is improved in embodiments for which the end 106 of the generally cylindrical portion of the shroud 100 is spaced a distance N from the inner surface 107 in the range of 55-61 mm, optionally or preferably in the range of 56-60 mm, optionally or preferably in the range of 57-58 mm, optionally or preferably in the range of 57-58 mm, optionally or preferably in the range of 57.5-58.5 mm, and optionally or preferably the distance N is or is about 58.0 mm. In embodiments, performance may be improved when N is in the range of 60-70 mm, optionally or preferably in the range of 61-69 mm, optionally or preferably in the range of 62-67 mm, optionally or preferably in the range of 63-67 mm, optionally or preferably in the range of 64-66 mm, and optionally or preferably the distance N is or is about 65 mm.

A free end of the shroud 100 includes a peripheral skirt 103, one purpose of which is to prevent dirt separated from the air being retrained into the airflow. The skirt 103 extends towards the end surface 108 and inclines outwardly slightly with respect to the cylindrical portion 102. A free peripheral edge of the skirt 103 is spaced a distance M from an inner surface of the end of the first dirt collection chamber at a distance in the range of 35-45 mm, optionally or preferably in the range of 36-44 mm, optionally or preferably in the range of 36-39 mm, optionally or preferably in the range of 36-38 mm, optionally or preferably in the range of 36.5-37.5 mm, and optionally or preferably the distance M is or is about 37.2 mm. In embodiments, the outer surface of skirt 103 is flush or generally flush with the outer surface of cylindrical portion 102.

All of the above dimensions/ranges of dimensions have been found, in isolation, to provide improved separation performance.

A number of synergies have been described with reference to advantageous ratios for certain dimensions of the cyclonic separator. Further advantages are obtained for embodiments having cyclonic separators whose dimensions embody two or more such synergistic ratios, i.e. combining two or more of the various sets of dimensions.

The embodiments described above and shown in the figures include a shroud 103 with dimensions which fulfil all of the above ranges, but it should be appreciated that this is not necessary. Indeed, improved performance can be found by utilising one, some or all of the dimensions ranges listed above.

Although the cyclonic separator device has been described in the context of apparatus 10 when the separator is horizontal in normal use, it has been found to provide improved performance when used in other types of surface cleaner apparatus, e.g. upright cleaners or cylinder cleaners, and other orientations, i.e. vertical or otherwise inclined.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A cyclonic separator device for removing dust or debris from dirt-laden air, the device including:
a first separating chamber for separating relatively coarse dust or debris from the dirt-laden air;
an inlet through which dirt-laden air is drawn into the first separating chamber;
a first dirt collection chamber in communication with the first separating chamber;
a shroud;
a second separating chamber positioned generally within the shroud for separating relatively fine dust or debris from the dirt-laden air cleaned by the first separating chamber,
a second dirt collection chamber in communication with the second separating chamber;
an outlet through which cleaner air exits the second separating chamber;
wherein the first separating chamber includes a generally cylindrical portion with a central axis and wherein the inlet is configured to direct the incoming dirt-laden air into said generally cylindrical portion such that it travels circumferentially around an inner surface of the first separating chamber,
wherein the shroud is positioned generally centrally of the generally cylindrical portion of the first separating chamber and the shroud has a generally cylindrical portion with openings therein for the passage of air therethrough towards the second separating chamber,
wherein the second dirt separating chamber includes:
an inlet through which cleaned dirt-laden air exiting the first separating chamber is drawn into the second separating chamber;
a generally frusto-conical portion with a central axis and the frusto-conical portion has an end-part in communication with the second dirt collection chamber through which fine dust or debris exits therethrough into the second dirt collection chamber, and wherein the inlet of the second separating chamber is configured to direct the incoming said cleaned dirt-laden air such that it travels circumferentially around an inner surface of the generally frusto-conical portion, and
wherein the second dirt collection chamber includes:
a first portion which surrounds an outer surface of the end part of the frusto-conical portion to define a space S1 therebetween; and
a second portion connected to the first portion,
wherein the first portion has a greater cross-sectional area than the second portion.

2. A cyclonic separator device according to claim 1 wherein said first portion of the second dirt collection chamber extends into a space S2 defined by the inner surface of the generally cylindrical portion of the shroud having said openings defined therein.

3. A cyclonic separator device for removing dust or debris from dirt-laden air, the device including:
a first separating chamber for separating relatively coarse dust or debris from the dirt-laden air;
an inlet through which dirt-laden air is drawn into the first separating chamber;
a first dirt collection chamber in communication with the first separating chamber;
a shroud;
a second separating chamber positioned generally within the shroud for separating relatively fine dust or debris from the dirt-laden air cleaned by the first separating chamber,
a second dirt collection chamber in communication with the second separating chamber;
an outlet through which cleaner air exits the second separating chamber;
wherein the first separating chamber includes a generally cylindrical portion with a central axis and wherein the inlet is configured to direct the incoming dirt-laden air into said generally cylindrical portion such that it travels circumferentially around an inner surface of the first separating chamber,
wherein the shroud is positioned generally centrally of the generally cylindrical portion of the first separating chamber and the shroud has a generally cylindrical portion having a height D with openings therein for the passage of air therethrough towards the second separating chamber,
wherein the second separating chamber includes:
an inlet through which cleaned dirt-laden air exiting the first separating chamber is drawn into the second separating chamber;
a generally frusto-conical portion with a central axis and the generally frusto-conical portion has an end part in communication with the second dirt collection chamber through which fine dust or debris exits therethrough into the second dirt collection chamber, and wherein the inlet of the second separating chamber is configured to direct the incoming said cleaned dirt-laden air such that it travels circumferentially around an inner surface of the generally frusto-conical portion, and
wherein a first portion of the second dirt collection chamber surrounds an outer surface of the end part of the generally frusto-conical portion to define a space S1 therebetween and said first portion of the second dirt collection chamber extends into a space S2 defined by the inner surface of the generally cylindrical portion of the shroud having said openings therein.

4. A cyclonic separator device according to claim 3 wherein the first portion of the second dirt collection chamber extends a height H into said space S2, and wherein the ratio (H:D) between height H and the height D of the generally cylindrical portion of the shroud is defined by the range:
1:1.2≤H:D≤1:4.5.

5. A cyclonic separator according to claim 4 wherein (H:D) is defined by the range:
1:1.6≤H:D≤1:2.0

6. A cyclonic separator according to claim 5 wherein (H:D) is defined by the range:
1:1.6≤H:D≤1:1.8.

7. A cyclonic separator according to claim 6 wherein (H:D) is or is about 1:1.7.

8. A cyclonic separator device according to any one of claims 4 to 7 wherein the second dirt collection chamber includes a second portion connected to the first portion,
wherein the first portion has a greater cross-sectional area than the second portion.

9. A cyclonic separator device according to any preceding claim wherein the first portion of the second dirt collection chamber has an end which is in sealed engagement or substantially sealed engagement with the end part of the frusto-conical portion.

10. A cyclonic separator device according to any preceding claim wherein the first portion of the second dirt collection chamber has a height H about its central axis, and the generally frusto-conical portion of the second separating chamber has a height H2 along its central axis, and wherein the ratio (H:H2) between them is defined by the range:
1:1.2≤H:H2≤1:7.

11. A cyclonic separator according to claim 10 wherein the ratio (H:H2) is defined by the range:
1:1.3≤H:H2≤1:5.

12. A cyclonic separator according to claim 10 or 11 wherein the ratio (H:H2) is defined by the range
1:1.4≤H:H2≤1:4.5.

13. A cyclonic separator according to claim 10, 11 or 12 wherein the ratio (H:H2) is or is about 1:4.3.

14. A cyclonic separator according to any one of claims 3 to 13 wherein:
the first portion of the second dirt collecting chamber is generally cylindrical and has a diameter D1 across its inner surface; and
the second portion of the second dirt collecting chamber is generally cylindrical and has a diameter D2 across its inner surface, wherein the ratio (D1:D2) is defined by the range:
1.05:1≤D1:D2≤1.60:1.

15. A cyclonic separator according to claim 14 wherein the ratio (D1:D2) is defined by the range:
1.07:1≤D1:D2≤1.20:1.

16. A cyclonic separator according to claim 15 wherein the ratio (D1:D2) is defined by the range:
1.07:1≤D1:D2≤1.15:1.

17. A cyclonic separator according to claim 16 wherein the ratio (D1:D2) is defined by the range:
1.07:1≤D1:D2≤1.13:1.

18. A cyclonic separator according to claim 17 wherein the ratio (D1:D2) is defined by the range:
1.07:1≤D1:D2≤1.1:1.

19. A cyclonic separator according to claim 18 wherein the ratio (D1:D2) is 1:09:1.

20. A cyclonic separator device according to any one of claims 3 to 19 wherein a third portion which is frusto-conical connects the first portion to the second portion.

21. A cyclonic separator device according to any one of claims 3 to 20 wherein the second dirt collection chamber includes a baffle positioned generally centrally thereof and which extends from a lower end of the second portion of the second dirt collection chamber upwardly towards the first portion of the second dirt collection chamber.

22. A cyclonic separator according to claim 21 wherein the baffle terminates in a conical portion.

23. A cyclonic separator device according to claim 22 wherein the conical portion extends into the end part of the frusto-conical portion of the second separating chamber.

24. A cyclonic separator device according to any preceding claim wherein:
an outer diameter U of the first portion of the second dirt collection chamber and an inner diameter V of the cylindrical portion of the shroud satisfy a ratio (U:V) defined by the range:
1:1.1≤U:V≤1:1.5.

25. A cyclonic separator device according to claim 24 wherein the ratio (U:V) defined by the range:
1:1.2≤U:V≤1:1.4.

26. A cyclonic separator device according to claim 25 wherein the ratio (U:V) is or is about 1:1.3.

27. A cyclonic separator for removing dust or debris from dirt-laden air, the device including:
a first separating chamber for separating relatively coarse dust or debris from the dirt-laden air;
an inlet through which dirt-laden air is drawn into the first separating chamber;
a first dirt collection chamber in communication with the first separating chamber;
a shroud;
an outlet through which cleaner air exits the first separating chamber;
wherein the first separating chamber includes a generally cylindrical portion with a central axis and wherein the inlet is configured to direct the incoming dirt-laden air into said generally cylindrical portion such that it travels circumferentially around an inner surface of the first separating chamber,
wherein the shroud is positioned generally centrally of the generally cylindrical portion of the first separating chamber and the shroud has a generally cylindrical portion having a height D with openings therein for the passage of air,
wherein the generally cylindrical portion of the shroud has an outer diameter K and the first separating chamber has an inner diameter P and wherein the ratio (K:P) lies in the range:
1:1.2≤K:P≤1:1.5.

28. A cyclonic separator according to claim 27 wherein the ratio (K:P) lies in the range:
1:1.3≤K:P≤1:1.5.

29. A cyclonic separator according to claim 28 wherein the ratio (K:P) lies in the range:
1:1.35≤K:P≤1:1.45.

30. A cyclonic separator according to claim 29 wherein the ratio (K:P) is or is about 1:1.39.

31. A cyclonic separator device according to any preceding claim wherein the generally cylindrical portion of the shroud has an outer diameter K in the range of 86-90 mm, optionally or preferably in the range of 87-89 mm, optionally or preferably K is or is about 87.7 mm.

32. A cyclonic separator device according to any preceding claim wherein the generally cylindrical portion of the shroud has an outer surface which is spaced a distance J from an inner surface of the generally cylindrical portion of the first separating chamber in the range of 15-18 mm, preferably in the range of 16-18 mm, optionally or preferably in the range of 16.5-17.5 mm, optionally or preferably in the range of 16.7-17.1 mm, optionally or preferably J is or is about 16.9 mm.

33. A cyclonic separator device according to any preceding claim wherein the shroud includes a peripheral skirt wherein the skirt has an outer diameter which is equal to an outer diameter of the generally cylindrical portion of the shroud.

34. A cyclonic separator device according to any preceding claim wherein an inner diameter P of the generally cylindrical portion of the first separating chamber is in the range of 120-125 mm, optionally or preferably in the range of 120-124 mm, optionally or preferably in the range of 121.5-123.5 mm, optionally or preferably P is or is about 122.4 mm.

35. A cyclonic separator device according to any preceding claim wherein the shroud includes a peripheral skirt which extends towards an end of the first dirt collection chamber, wherein a free peripheral edge of the skirt is spaced a distance M from an inner surface of the end of the first dirt collection chamber at a distance in the range of 35-45 mm, optionally or preferably in the range of 36-44 mm, optionally or preferably in the range of 36-39 mm, optionally or preferably in the range of 36-38 mm, optionally or preferably in the range of 36.5-37.5 mm, and optionally or preferably the distance M is or is about 37.2 mm.

36. A cyclonic separator device according to any preceding claim wherein an end of the generally cylindrical portion of the shroud faces an inner surface of an end of the first dirt collection chamber, wherein said end of the generally cylindrical portion of the shroud is spaced from the inner surface of an end of the first dirt collection chamber a distance N in the range of 60-70 mm, optionally or preferably in the range of 61-69 mm, optionally or preferably in the range of 62-67 mm, optionally or preferably in the range of 63-67 mm, optionally or preferably in the range of 64-66 mm, and optionally or preferably the distance N is or is about 65 mm.

37. A cyclonic separator device according to any preceding claim wherein the shroud has a central axis which is substantially coaxial or coaxial with the central axis of the generally cylindrical portion of the first separating chamber.

38. A cyclonic separator device according to any preceding claim wherein the shroud is connected to one end of the first separating chamber and is free at an opposite end.

39. A surface cleaning apparatus including a separator device according to any preceding claim.

40. A surface cleaning apparatus according to claim 39 wherein the apparatus includes:
a surface cleaning tool;
a housing supporting a suction source; and
an elongate member connecting the surface cleaning tool to the housing, said elongate member including a passage for carrying dirt-laden air from the floor head to the dirt collection chamber.

41. A surface cleaning apparatus according to claim 40 wherein the elongate member is disconnectable from the surface cleaning tool.

42. A surface cleaning apparatus according to claim 40 or claim 41 wherein the elongate member is disconnectable from the housing.

43. A surface cleaning apparatus according to any one of claims 39 to 42 wherein the apparatus is a handheld surface cleaning apparatus.

44. A surface cleaning apparatus according to any one of claims 39 to 43 wherein an axis of the cyclonic separation device extends transverse to an elongate axis of the elongate member.

45. A surface cleaning apparatus according to any one of claims 39 to 44 wherein an axis of the cyclonic separation device extends perpendicular to an elongate axis of the elongate member.

46. A surface cleaning apparatus according to any one of claims 39 to 45 wherein the source of suction is a fan rotatable by a motor.

47. A surface cleaning apparatus according to any one of claims 39 to 46 wherein, in normal use, the first and second cyclonic separating chambers are generally horizontal or the elongate axes thereof are generally horizontal.

48. Any novel feature or novel combination of features described herein and/or in the accompanying drawings.
